(19) United States
(12) Patent Application Publication
(10) Pub. No.: US 2024/0069948 A1
(43) Pub. Date: Feb. 29, 2024

(54) MAPPING COMMON PATHS FOR APPLICATIONS

(71) Applicant: VMware, Inc., Palo Alto, CA (US)

(72) Inventors: Alexander Julian THOMAS, Brooklyn, NY (US); Amit CHOPRA, Cedar Park, TX (US); Anjali MANGAL, Cupertino, CA (US); Xiaosheng WU, Mountain View, CA (US); Ereli ERAN, Wayland, MA (US)

(73) Assignee: VMware, Inc., Palo Alto, CA (US)

(21) Appl. No.: 17/896,718

(22) Filed: Aug. 26, 2022

(51) Int. Cl. G06F 9/455

(52) U.S. Cl. CPC G06F 9/45558; G06F 2009/4557; G06F 2009/45583; G06F 2009/45595

(57) ABSTRACT

Mapping of applications by the most common file path in which they are installed or found to be running. Embodiments of the disclosure may determine the most commonly occurring hash values appearing in events generated by a virtualized network. These most commonly occurring hash values may correspond to the hash values of file paths associated with the greatest number of detected events. The database may then be queried to determine the most commonly occurring file path for each of these hash values. A table of such most commonly occurring file paths and their associated hash values may then be compiled and stored. Use of the most commonly occurring file path in lieu of an alert's actual file path may prevent undesired or malicious processes from going undetected by simply adopting a new file path that has yet to be recognized as being associated with undesired behavior.

### FIELD

The present disclosure relates generally to network virtualization. More specifically, the present disclosure relates to systems and methods for common path mapping of applications.

### BACKGROUND

Contemporary large-scale computing systems provide improved access to application programs and other computing resources such as storage. In particular, such computing systems allow multiple instances of applications to be simultaneously generated and run by many different users. While offering improved access to applications and other computing resources, such systems are not without their challenges. For example, the mapping of applications by file path, for purposes such as security, can be difficult in such environments. Use of process path entries of alerts or other events may result in inaccuracies when attempting to characterize such events, as application instances are typically accessed via multiple different file paths across different sensors, servers, machines, or the like. Reliance solely on hash values of particular process paths is often similarly inaccurate, as each application can employ multiple hash values.

### SUMMARY

In some embodiments of this disclosure, systems and methods are described for mapping of applications by their most commonly-arising file paths. Databases of virtual network event data, such as security events, alerts, or the like, may be maintained to store events that include the file path of the process generating the event, the hash value of the file path, and associated data such as the event day/time. Systems of embodiments of the disclosure may determine the most commonly occurring hash values stored in such a database, corresponding to the hash values of file paths associated with the greatest number of events. The database is then queried to determine the most commonly occurring file path for each of these hash values. A table of such most commonly occurring file paths and their associated hash values may then be compiled and used in the identification of those applications associated with, e.g., a generated alert.

For example, an incoming alert may be received concerning a particular application, identified by process ID, which may include the additional telemetry like the file path of the process, as well as a hash value assigned to the process by the application in question. The alert's hash value may then be cross-referenced with the list of commonly occurring hashes and their most commonly occurring file paths. If a match is found, the most commonly occurring file path corresponding to the matching hash value may be used instead of the alert's file path in determining whether and how to act on the alert, e.g., determining whether the alert represents a security threat. In this manner, use of the most commonly occurring file path in lieu of the alert's actual file path may prevent undesired or malicious processes from going undetected by simply using a new file path that has yet to be associated with undesired behavior.

In some embodiments of the disclosure, a method of identifying a common file path of an application instance is described, and includes: determining most commonly occurring hash values of events stored in an electronic database, the events generated for an electronic computing network executing instances of application programs, the events further including the hash values of file paths, the file paths associated with processes of respective instances of the application programs; for each determined hash value, retrieving, from the electronic database, a most commonly occurring file path of the file paths associated with the each retrieved hash value; and storing, in one or more memories, the most commonly occurring ones of the hash values and their associated most commonly occurring file paths.

In some other embodiments of the disclosure, a non-transitory computer-readable storage medium is described. The computer-readable storage medium includes instructions configured to be executed by one or more processors of a computing device and to cause the computing device to carry out steps that include: determining most commonly occurring hash values of events stored in an electronic database, the events generated for an electronic computing network executing instances of application programs, the events further including the hash values of file paths, the file paths associated with processes of respective instances of the application programs; for each determined hash value, retrieving, from the electronic database, a most commonly occurring file path of the file paths associated with the each retrieved hash value; and storing, in one or more memories, the most commonly occurring ones of the hash values and their associated most commonly occurring file paths.

Other aspects and advantages of embodiments of the disclosure will become apparent from the following detailed description taken in conjunction with the accompanying drawings which illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIG. 1 is a diagram illustrating an exemplary server cluster suitable for use with embodiments of the disclosure;

FIG. 2 is a block diagram representation of an exemplary event intake and storage system for use with embodiments of the disclosure;

FIG. 3 is a block diagram representation of another exemplary event intake and storage system for use with embodiments of the disclosure;

FIG. 4 is an exemplary table of hash values and associated most commonly occurring file paths, determined and stored in accordance with embodiments of the disclosure;

FIG. 5 is a flow chart depicting a method for generating the table of FIG. 4, in accordance with embodiments of the disclosure; and

FIG. 6 is a flow chart depicting a method for determining alert properties using the table of FIG. 4, in accordance with embodiments of the disclosure.

### DETAILED DESCRIPTION

Certain details are set forth below to provide a sufficient understanding of various embodiments of the disclosure. However, it will be clear to one skilled in the art that embodiments of the disclosure may be practiced without one or more of these particular details, or with other details. Moreover, the particular embodiments of the present disclosure described herein are provided by way of example and should not be used to limit the scope of the disclosure to these particular embodiments. In other instances, hardware components, network architectures, and/or software operations have not been shown in detail in order to avoid unnecessarily obscuring the disclosure.

In some embodiments of this disclosure, systems and methods are described for mapping of applications by their most common file paths. Systems of embodiments of the disclosure may determine the most commonly occurring hash values appearing in events generated by a virtualized network. These most commonly occurring hash values may correspond to the hash values of file paths associated with the greatest number of detected events. The database is then queried to determine the most commonly occurring file path for each of these hash values. A table of such most commonly occurring file paths and their associated hash values may then be compiled and stored.

In embodiments of the disclosure, this table may offer benefits when used in various tasks such as the classification of events. For example, an incoming alert may be received concerning a particular process which may or may not present a security threat. Such alerts may typically include the file path of the process which led to the alert, as well as a hash value assigned to the process. The alert's hash value may be cross-referenced with the above described table of common hashes and their most commonly occurring file paths. If a match is found, the most commonly occurring file path corresponding to the matching hash value may be used instead of the alert's file path in determining whether and how to act on the alert, e.g., in input of the alert to a machine learning model employing a feature store, to determine whether the alert represents a security threat. In this manner, use of the most commonly occurring file path in lieu of the alert's actual file path may prevent undesired or malicious processes from going undetected by simply adopting a new file path that has yet to be recognized as being associated with undesired behavior.

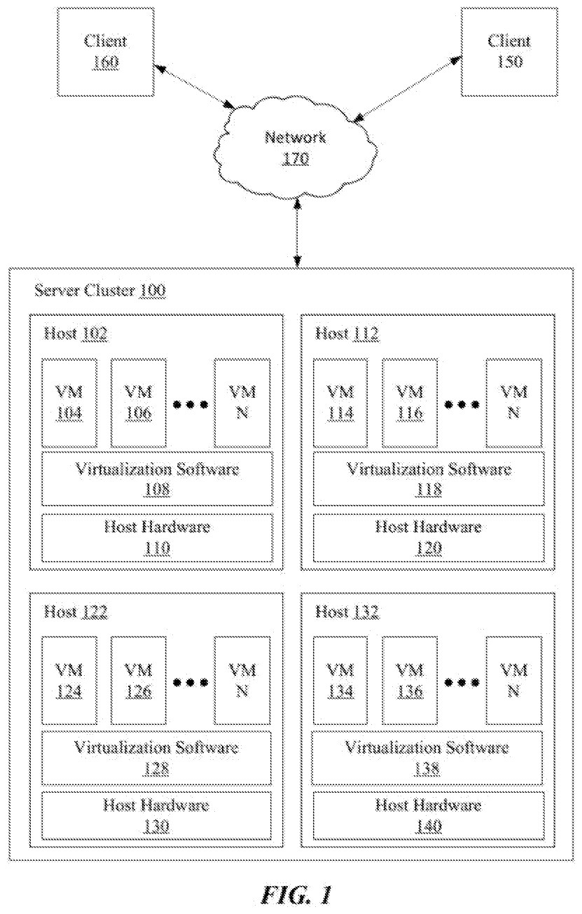

FIG. 1 is a diagram illustrating an exemplary server cluster suitable for use with embodiments of the disclosure. Server cluster 100 can include hosts 102, 112, 122 and 132. While a four host system is shown for exemplary purposes it should be appreciated that server cluster 100 could include a larger or smaller number of hosts. Each host 102-132 includes host hardware 110-140, which can include a designated amount of processing, memory, network and/or storage resources. In some embodiments, each of the hosts provide the same amount of resources, and in other embodiments, the hosts are configured to provide different amounts of resources to support one or more virtual machines (VMs) running on the hosts. Each of the VMs can be configured to run a guest operating system that allows for multiple applications or services to run within the VM.

Each of hosts 102, 112, 122 and 132 are capable of running virtualization software 108, 118, 128 and 138, respectively. The virtualization software can run within a virtual machine (VM) and includes management tools for starting, stopping and managing various virtual machines running on the host. For example, host 102 can be configured to stop or suspend operations of virtual machines 104 or 106 utilizing virtualization software 108. Virtualization software 108, commonly referred to as a hypervisor, can also be configured to start new virtual machines or change the amount of processing or memory resources from host hardware 110 that are assigned to one or more VMs running on host 102. Host hardware 110 includes one or more processors, memory, storage resources, I/O ports and the like that are configured to support operation of VMs running on host 102. In some embodiments, a greater amount of processing, memory or storage resources of host hardware 110 is allocated to operation of VM 104 than to VM 106. This may be desirable when, e.g., VM 104 is running a larger number of services or running on a more resource intensive operating system than VM 106. Clients 140 and 150 are positioned outside server cluster 100 and can request access to services running on server cluster 100 via network 160. Responding to the request for access and interacting with clients 140 and 150 can involve interaction with a single service or in other cases may involve multiple smaller services cooperatively interacting to provide information requested by clients 140 and/or 150.

Hosts 102, 112, 122 and 132, which make up server cluster 100, can also include or have access to a storage area network (SAN) that can be shared by multiple hosts. The SAN is configured to provide storage resources as known in the art. In some embodiments, the SAN can be used to store event data generated during operation of server cluster 100. While description is made herein with respect to the operation of the hosts 110-140, it will be appreciated that those of hosts 110-140 provide analogous functionality, respectively.

While FIG. 1 describes a computing system capable of implementing virtual applications on VMs, it may be observed that hosts 102, 112, 122 and 132 may also execute instances of application programs on their host hardware 110, 120, 130, 140 without use of any VMs. Accordingly, embodiments of the disclosure contemplate mapping of applications by most common file path, where mapped applications may be any applications, whether run on a VM or otherwise.

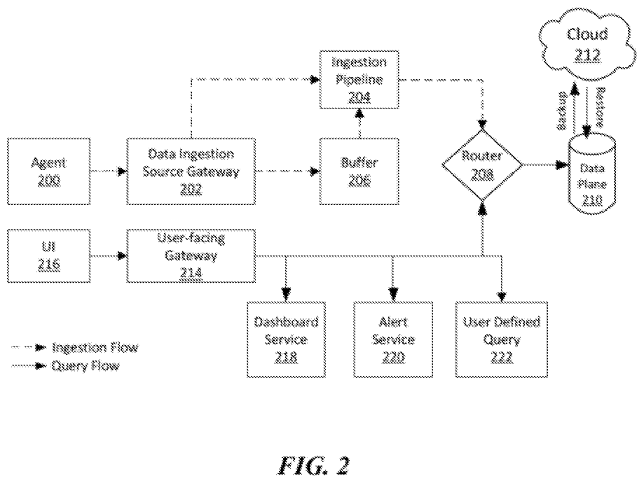

FIG. 2 is a block diagram representation of an exemplary event intake and storage system for use with embodiments of the disclosure. Agent 200 may include a sensor or any other computational network element capable of detecting and/or characterizing any portion of network traffic. Agent 200 can be incorporated into many different types of environments (e.g., as a cloud infrastructure, an on premises infrastructure, or in a specific embodiment server cluster 100) to transmit log data that is generated in response to many different types of events to data ingestion source gateway 202. For example, agent 200 can generate telemetry stored in an events table that represents various events that are captured during normal or irregular operation of agent 200. The telemetry could include any number of metadata and a time stamp that helps to determine how often particular types telemetry events are generated. The metadata could be used to help identify whether the telemetry events are related to, e.g., security events, detected errors, or more normal activity such as a login or file download event. Data ingestion source gateway 202 is configured to forward event data received from agent 200 to ingestion pipeline 204 and/or buffer 206. Event data received at ingestion pipeline 204 is then forwarded on to router 208, which distributes the event data to data plane 210. Event data can be sent to buffer 206 when a rate at which event data is being supplied by agent 200 exceeds a rate ingestion pipeline 204 can handle. In such a situation, buffer 206 may be a queue or any other suitable data structure for data storage and retrieval. As one example, buffer 206 can take the form of a Kafka module able to handle many extremely large streams of data. In some embodiments, the Kafka module can be configured to distribute multiple streams of the event data to separate computing resources to keep up with a rate at which the event data is being produced. Such a situation may arise when the system associated with agent 200 is undergoing high usage and/or experiencing large numbers of errors or warnings. Data plane 210 can be organized into multiple shards that improve reliability of the data store but may also limit a rate at which the stored log data can be retrieved. In some embodiments, the data can also be stored on a cloud service 212. Cloud service 212 can provide access to the event data during an on premise server outage or be used to restore data lost due to equipment failure.

A user is able to retrieve relevant subsets of the event data from data plane 210 by accessing user-facing gateway 214 by way of user interface 216. Data representative of the event data is obtained by dashboard service 218, alert service 220 and user-defined query module 222. Dashboard service 218 is generally configured to retrieve event data from data plane 210 within a particular temporal range or that has a particular log type. Dashboard service 218 can include a number of predefined queries suitable for display on a dashboard display. Dashboard service 218 could include conventional queries that help characterize metrics such as error occurrence, user logins, server loading, etc. Alert service 220 can be configured to alter the user when the event data indicates a serious issue and user-defined query module 222 allows a user to define custom queries particularly relevant to operation of the application associated with agent 200. With this type of configuration, dashboard service 218, alert service 220 and user-defined query module 222 each route requests for data to support the alerts and queries to data plane 210 by way of router 208. Queries are typically run to retrieve the entire dataset relevant to the query or alert in order to be sure time-delayed logs are not missed from the queries. In this way, the queries can be sure to obtain all data relevant to the query.

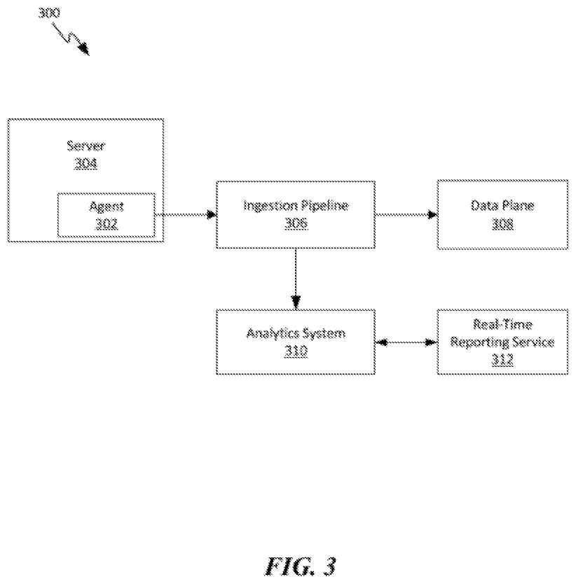

FIG. 3 is a block diagram representation of another exemplary event intake and storage system 300 for use with embodiments of the disclosure. In particular, agent 302 can be installed within operational system 304 and configured to transmit a stream of event data generated by operational system 304 to ingestion pipeline 306. In some embodiments, the connection between agent 300 and the ingestion pipeline 302 can be a direct connection or alternatively be transmitted across a larger network. Ingestion pipeline 302 can be configured to perform basic formatting and parsing operations upon the event data prior to transmitting the event data to data plane 308. In some embodiments, the event data stored in data plane 308 can be backed up to other servers located on premises or at a number of distributed cloud computing facilities. Ingestion pipeline 306 can also be configured to provide data to analytics data storage 308. Analytics system 310 can include a robust set of filters that processes only the event data pertaining to a current set of metrics requested from real-time display system 310. For example, when processing the event data, any event data files failing to match one or more event data criteria can be discarded to save space and reduce access time to the event data stored on analytics data storage 308. In some embodiments, event data that is saved can be reduced in size by including only metrics currently being requested by real-time reporting service 312. Saving only a subset of the event data relevant to what is currently being used by the real-time reporting service during the data ingestion process allows for much more rapid performance of the system 300. In some embodiments, the speed of real-time reporting service 312 is increased by at least an order of magnitude when compared with a configuration similar to the one depicted in FIG. 2.

Analytics system 310 may be in electronic communication with any other network elements. For example, analytics system 310 may access the above described SAN, or may access data plane 210 to compile the above described table of most commonly occurring file paths and their associated hash values. System 310 may also access any network-accessible service to replace tabulated most commonly occurring file paths in received alerts, and transmit them to, e.g., a feature store for application identification, threat identification, or the like.

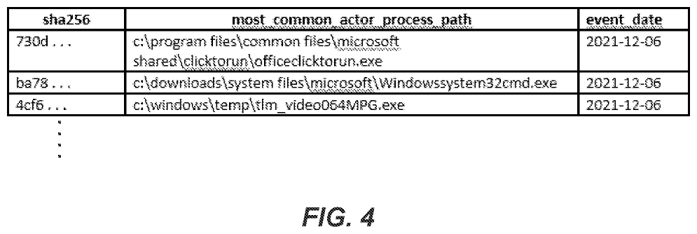

FIG. 4 is an exemplary table of hash values and associated most commonly occurring file paths, determined and stored in accordance with embodiments of the disclosure. In known manner, agent 200 may retrieve and log events in, e.g., the above described SAN, data plane 210, and/or a database accessible via cloud 212. Logged events may typically include one file path of the process that led to generation of the event, as well as a hash value, such as an sha256 hash, generated for the content of the process. The N most commonly occurring hash values logged may then be determined. The database may then be queried to search for and retrieve the most commonly occurring file path for each of the N retrieved hash values. That is, each of the N retrieved hash values may appear more than once in, e.g., data plane 210, with each appearance representing another logged event and having an associated file path. The most commonly occurring file path of these appearances is then selected. A table such as that of FIG. 4 may be stored in, e.g., a memory allocated for and accessible by analytics system 310, and may include the N retrieved most commonly occurring hash values, the most commonly occurring file path retrieved for each of these N hash values, and any other desired data, such as the date or time stamp of the corresponding event, and the like. While the data of FIG. 4 is shown as being arranged in tabular form, embodiments of the disclosure contemplate storage of this data in any manner capable of being retrieved for further analysis.

Logged events may be any events generated from network operation. For example, events may be security events or alerts. Embodiments of the disclosure contemplate generation, storage, and analysis of any types of events that may be generated in connection with operation of a computer network.

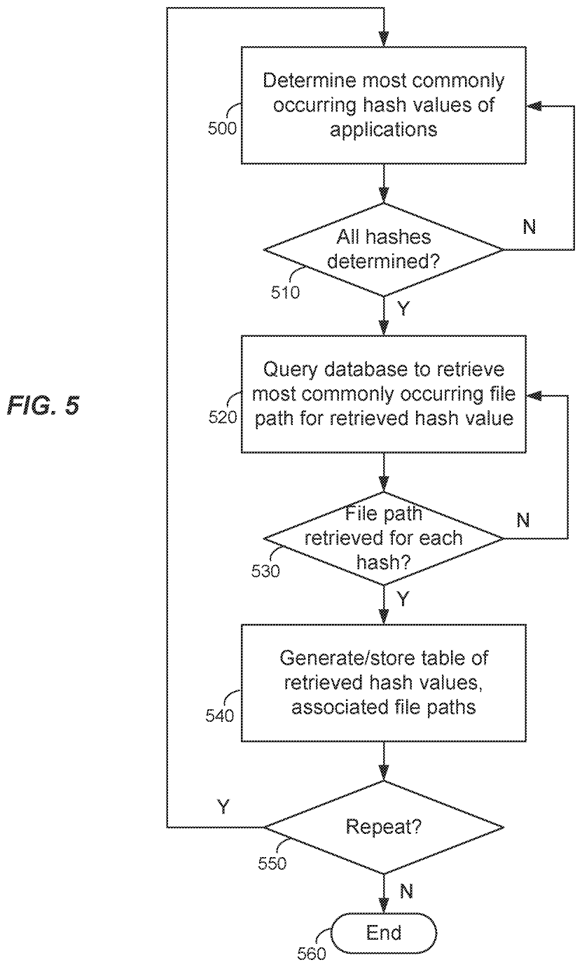

FIG. 5 is a flow chart depicting a method for generating the table of FIG. 4, in accordance with embodiments of the disclosure. Initially, analytics system 310 may determine those hash values which appear most commonly in recent events (Step 500). As above, sensors or other components of agent 200 may generate events such as alerts, which may include a file path of the process which caused the alert to be generated, as well as a corresponding hash value generated by the sensor, e.g., the process hash, or the hash of the content of the process. Events generated by agent 200 may be stored in a database such as a data plane 210 and/or a database accessible via cloud 212. In some embodiments of the disclosure, analytics system 310 may compute the top N (where N is any predetermined number) hash values, such as sha356 hash values, of the events stored in the database/data plane 210. The computation may be for all database entries, or any desired subset thereof, e.g., across all customers, certain customers, or the like. In some embodiments of the disclosure, analytics system 310 may select a predetermined number of stored events generated within a most recent time period (e.g., 1 million events selected from among those stored events which have been generated within the past 24 hours). Analytics system 310 may then compute the top N hash values of this sample of events, where sampling may be based on any desired criteria such as by the number of events for a particular organization or customer, device count, or the like. In some embodiments of the disclosure, the events used for this computation may be only those with hash values which appear across more than one organization or customer, and more than one device, to avoid hash values which may be deemed as associated with excessively low-use applications.

In some embodiments of the disclosure, the N value may be any desired number. Similarly, any number of stored events may be selected for use in computation of top hash values. Stored events may be selected in any manner, such as by any predetermined time window within which these events were generated. In some embodiments of the disclosure, the submitted query may be performed across all stored events, or may be performed on a selected subset of the stored events, such as a predetermined number (e.g., 1 million) of the most recently generated events, or the like. Subsets of stored events may be selected in any manner, such as a random sampling of those events occurring within a desired time period, a selection of most recent events, or the like. The query of Step 500 may be limited to such a predetermined time window in order to capture more recent hash values (i.e., to assist in identifying recently-used applications, which are more likely to have generated a newly-received event or alert). For example, the query of Step 500 may be for the most recent 24 hours, the most recent 12 hours, or the like, although any time window is contemplated.

The hash determination process continues until all N desired hash values have been computed (Step 510). Once this is the case, or if less than N hash values can be computed, the database/data plane 210 is queried to retrieve the most commonly appearing (e.g., most often occurring) file path for each of the N retrieved hash values (Step 520). In some embodiments of the disclosure, the database/data plane 210 is queried to retrieve the most commonly occurring file path among all versions of each hash value, with the most commonly occurring path determined in any desired manner. For example, the most commonly occurring file path may be determined by selecting the majority file path from among all file paths for all versions of a given hash value, if such a majority path exists. Alternatively, the most commonly occurring file path may be determined via any other suitable method, such as selecting the file path with the greatest number of occurrences from among all file paths for all versions of a given hash value, if no majority path exists. Embodiments of the disclosure contemplate any method of selecting a most commonly occurring file path for all versions of a given hash value.

In some embodiments of the disclosure, the query of Step 520 may be limited to a predetermined time window, to capture more recent file paths (i.e., to assist in mapping more recently-used applications, which are more likely to have generated a newly-received event or alert). For example, the query of Step 520 may be for the most recent 3 months, the most recent 1 month, or the like. Any time window is contemplated.

Once a most commonly occurring file path is selected for each of the N determined hash values (Step 530), a table of the retrieved hash values and their associated file paths may be generated/stored (Step 540), resulting in a table similar to that of FIG. 4. It is noted that the database/data plane 210 may be updated as new events occur. That is, server cluster 100 may execute different instances of different application programs over time, and system 300 may thus continuously detect or generate events for those applications. In this manner, a time-windowed sample of the hash values and associated file paths stored in database/data plane 210 may continuously vary in number. Accordingly, in some embodiments of the disclosure, the above process of Steps 500-540 may be repeated at any desired times (Step 550), to reflect more recent hash values and associated file paths. Steps 500-540 may be repeated at any desired times or time intervals, e.g., every 24 hours, or the like, so that the table of Step 540 reflects hash values and file paths of more recently executed processes. Once repetition of Steps 500-540 is no longer desired, the process of FIG. 5 may be terminated (Step 560).

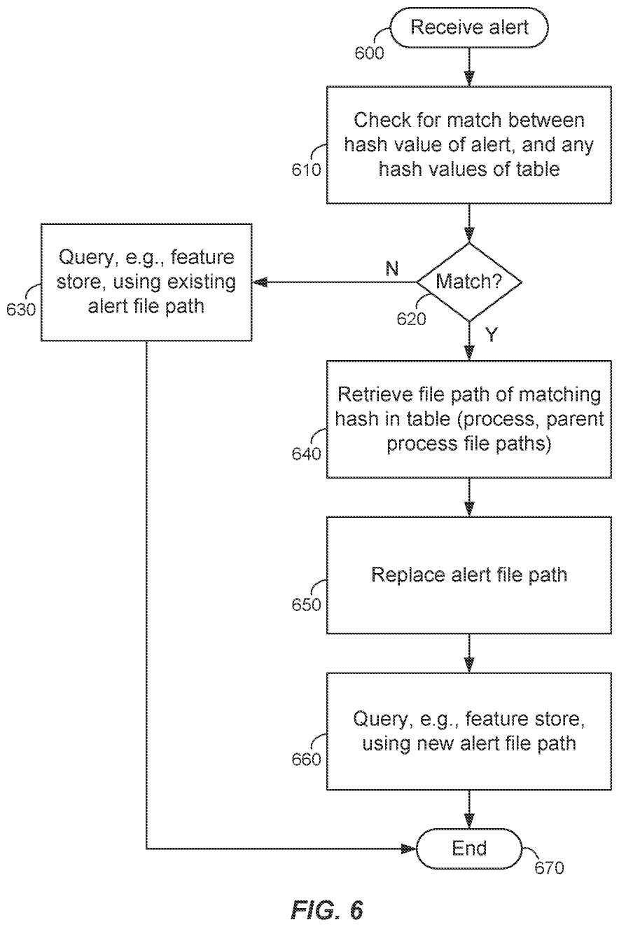

Tables generated by the processes of FIG. 5 provide a number of advantages, including for example the improved classification of alerts or other events. FIG. 6 is a flow chart depicting a method for alert classification using the table of FIG. 4, in accordance with embodiments of the disclosure. Initially, analytics system 310 may receive an alert (Step 600), such as an alert generated by agent 302. Alerts may have any format, but in some embodiments may be of the form {path: “path1”, path_hash:hash(“path1”), parentpath: “path2”, parent_path_hash: hash(“path2”)}. That is, each alert may, in a known manner, include the file path of the process of the main actor in the alert, the hash value assigned to the process by the application in question, the parent file path (if any), and the hash value assigned to the parent file path. Analytics system 310 may then check for a match between the alert's hash value, hash(“path1”), and one of the N hash values of the table generated by the processes of FIG. 5 (Step 610). If no match is found (Step 620), the existing alert may be used in any desired manner, such as in submission to a machine learning model designed and trained to, e.g., classify alerts as belonging to specific processes, presenting certain threat levels, or the like (Step 630). In some embodiments of the disclosure, these machine learning models may be assembled in part from features stored in a feature store, or library of predefined elements, so as to classify input data (e.g., alerts) as belonging to certain features or attributes. For example, alerts may be input to a model designed to query a feature store, with the query requesting use of predefined programs in the feature store that classify the alert as belonging to features such as the type of threat presented by the alert. Feature stores, and their use within machine learning models, are known.

If a match is found between a hash value of the alert and one of the N tabulated hash values, the file path corresponding to the matching tabulated hash value is retrieved (Step 640). Both the path and parentpath may be retrieved, if both exist. In particular, the matching parentpath is retrieved if it exists. The file paths of the alert are then replaced with any retrieved file paths (Step 650). That is, path1 and path2 are replaced with the file paths retrieved in Step 640. If only one file path is retrieved, then only that path is replaced. The new alert, containing one or more retrieved file paths from the table generated in FIG. 5, is then employed in any manner an alert may be used (Step 660), e.g., it may be submitted as a portion of a query to a machine learning model (including submission to a feature store) designed to classify the alert. That is, if common file paths matching the hash value of the alert are found in the table of FIG. 5, the alert is submitted to the machine learning model of Step 630 with the common file paths instead of the original file paths of the generated alert. In this manner, threats or other characterizations of the alert may be more readily recognized by the machine learning model, as the file paths are already well known and thus more likely to be recognized. Once the alert is successfully characterized, the process of FIG. 6 may be terminated (Step 670).

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings. One of ordinary skill in the art will also understand that various features of the embodiments may be mixed and matched with each other in any manner, to form further embodiments consistent with the disclosure.

What is claimed is:

1. A method of identifying a common file path of an application instance, the method comprising:
determining most commonly occurring hash values of events stored in an electronic database, the events generated for an electronic computing network executing instances of application programs, the events further including the hash values of file paths, the file paths associated with processes of respective instances of the application programs;
for each determined hash value, retrieving, from the electronic database, a most commonly occurring file path of the file paths associated with the each retrieved hash value; and
storing, in one or more memories, the most commonly occurring ones of the hash values and their associated most commonly occurring file paths.

2. The method of claim 1, further comprising:
receiving an alert, the alert having a corresponding hash value;
determining whether the hash value of the received alert matches a hash value of the stored most commonly occurring ones of the hash values; and
if the hash value of the received alert matches a hash value of the stored most commonly occurring ones of the hash values:
retrieving the stored file path associated with the matching hash value of the stored most commonly occurring ones of the hash values; and
replacing a file path of the alert with the retrieved stored file path.

3. The method of claim 2, wherein:
each file path comprises at least one of a process file path or a parent process file path;
the retrieving the stored file path further comprises retrieving one or more of a stored process file path or a stored parent process file path; and
the replacing further comprises one or more of:
replacing a process file path of the alert with the retrieved stored file path; or
replacing a parent process file path of the alert with the retrieved stored parent process file path.

4. The method of claim 2, further comprising querying a feature store database using the retrieved stored file path.

5. The method of claim 1, wherein each file path comprises one or more of a process file path or a parent process file path.

6. The method of claim 1, wherein the determining most commonly occurring hash values further comprises determining a predetermined number of the most commonly occurring hash values from the electronic database.

7. The method of claim 1, wherein the retrieving a most commonly occurring file path further comprises, for each retrieved hash value, determining a most commonly occurring file path from among the file paths associated with each version of the each retrieved hash value.

8. The method of claim 1, wherein the storing further comprises storing the most commonly occurring ones of the hash values and their associated most commonly occurring file paths as a table.

9. The method of claim 1, further comprising repeating the determining most commonly occurring hash values, the retrieving a most commonly occurring file path, and the storing in order, so as to determine updated ones of the most commonly occurring hash values and updated ones of the most commonly occurring file paths.

10. The method of claim 9, further comprising repeating the determining most commonly occurring hash values, the retrieving a most commonly occurring file path, and the storing in order at predetermined times, so as to repeatedly determine updated ones of the most commonly occurring hash values and updated ones of the most commonly occurring file paths.

11. The method of claim 1, wherein the event data are security event data, and wherein the file paths are file paths associated with events of respective instances of the application programs.

12. A non-transitory computer-readable storage medium storing instructions configured to be executed by one or more processors of a computing device, to cause the computing device to carry out steps that include:
determining most commonly occurring hash values of events stored in an electronic database, the events generated for an electronic computing network executing instances of application programs, the events further including the hash values of file paths, the file paths associated with processes of respective instances of the application programs;
for each determined hash value, retrieving, from the electronic database, a most commonly occurring file path of the file paths associated with the each retrieved hash value; and
storing, in one or more memories, the most commonly occurring ones of the hash values and their associated most commonly occurring file paths.

13. The non-transitory computer-readable storage medium of claim 12, wherein the instructions, when executed by the one or more processors of the computing device, further cause the computing device to carry out steps that include:
receiving an alert, the alert having a corresponding hash value;
determining whether the hash value of the received alert matches a hash value of the stored most commonly occurring ones of the hash values; and
if the hash value of the received alert matches a hash value of the stored most commonly occurring ones of the hash values:
retrieving the stored file path associated with the matching hash value of the stored most commonly occurring ones of the hash values; and
replacing a file path of the alert with the retrieved stored file path.

14. The non-transitory computer-readable storage medium of claim 13, wherein:
each file path comprises at least one of a process file path or a parent process file path;
the retrieving the stored file path further comprises retrieving one or more of a stored process file path or a stored parent process file path; and
the replacing further comprises one or more of:
replacing a process file path of the alert with the retrieved stored file path; or
replacing a parent process file path of the alert with the retrieved stored parent process file path.

15. The non-transitory computer-readable storage medium of claim 13, wherein the instructions, when executed by the one or more processors of the computing device, further cause the computing device to carry out steps that include querying a feature store database using the retrieved stored file path.

16. The non-transitory computer-readable storage medium of claim 13, wherein each file path comprises one or more of a process file path or a parent process file path.

17. The non-transitory computer-readable storage medium of claim 13, wherein the retrieving a most commonly occurring file path further comprises, for each retrieved hash value, determining a most commonly occurring file path from among the file paths associated with each version of the each retrieved hash value.

18. The non-transitory computer-readable storage medium of claim 13, wherein the instructions, when executed by the one or more processors of the computing device, further cause the computing device to carry out steps that include repeating the determining most commonly occurring hash values, the retrieving a most commonly occurring file path, and the storing in order, so as to determine updated ones of the most commonly occurring hash values and updated ones of the most commonly occurring file paths.

19. The non-transitory computer-readable storage medium of claim 13, wherein the event data are security event data, and wherein the file paths are file paths associated with events of respective instances of the application programs.

20. A computer system, comprising:
one or more processors; and
memory storing one or more programs configured to be executed by the one or more processors, the one or more programs including instructions for:
determining most commonly occurring hash values of events stored in an electronic database, the events generated for an electronic computing network executing instances of application programs, the events further including the hash values of file paths, the file paths associated with processes of respective instances of the application program;
for each determined hash value, retrieving, from the electronic database, a most commonly occurring file path of the file paths associated with the each retrieved hash value; and
storing, in one or more memories, the most commonly occurring ones of the hash values and their associated most commonly occurring file paths.
